(19) United States
(12) Patent Application Publication
(10) Pub. No.: US 2022/0025149 A1
(43) Pub. Date: Jan. 27, 2022

(54) MATERIALS HAVING TUNABLE PROPERTIES, AND RELATED SYSTEMS AND METHODS

(71) Applicant: HyperDamping, Inc., Cambridge, MA (US)

(72) Inventors: Carsten BOERS, Cambridge, MA (US); Ryan Lee HARNE, Dublin, OH (US); Jason Milton WHALEY, Belmont, MA (US)

(73) Assignee: HyperDamping, Inc., Cambridge, MA (US)

(21) Appl. No.: 17/496,855

(22) Filed: Oct. 8, 2021

Related U.S. Application Data
(63) Continuation of application No. PCT/US2020/027323, filed on Apr. 8, 2020.
(60) Provisional application No. 62/831,279, filed on Apr. 9, 2019.

(51) Int. Cl. C08J 9/42; C08J 9/00; F16F 3/093; F16F 7/12

(52) U.S. Cl. CPC C08J 9/42; C08J 9/0061; F16F 3/093; F16F 7/12; F16F 2230/36; F16F 2226/04; F16F 2228/066; F16F 2228/14; C08J 2387/00

(57) ABSTRACT

Materials, methods, and manufacture for controlled kinetic energy conversion are provided. In an aspect, a material may include a first section having a first set of voids and an associated first set of properties (e.g., mechanical, thermal), and a second section having a second set of voids and an associated second set of properties. The second set of properties of the second section may be configured to be selectively adjusting by at least partially filling one or more of the second set of voids with a substance. The substance may be configured to inhibit, prevent, or otherwise affect a desired deformation or collapse behavior of the material in response to a load.

### CROSS-REFERENCE TO RELATED APPLICATIONS

This application is a continuation of International Application No. PCT/US2020/027323, filed Apr. 8, 2020, which claims priority to and the benefit of U.S. Provisional Patent Application No. 62/831,279, filed Apr. 9, 2019, titled “Materials Having Tunable Properties, And Related Systems And Methods,” the disclosure of each of which is incorporated by reference herein.

### TECHNICAL FIELD

The present disclosure relates generally to materials having tunable properties (e.g., mechanical, thermal) and, more specifically, to materials having voids that can be selectively filled with one or more substances.

### BACKGROUND

Materials used in various applications may be subjected statically and/or dynamically applied loads, forces, stresses, conditions, constraints, and the like (collectively, “load(s)”). Such applications may include, for example, those used in or relating to architecture, manufacturing, ballistics, transportation (e.g., automotive, aeronautical), infrastructure (e.g., roads, sewage, mass transit), packaging, and the like. Given the different loads that materials may be subjected to in these applications, as well as the different properties (e.g., mechanical, thermal) required by these applications, it is desirable have materials with tunable properties for use in different applications. In an example, a material with tunable properties can be used in a variety of applications. In another example, a material with tunable properties can provide properties that are well suited to meet performance needs in multiple loading environments.

### SUMMARY

Systems, apparatus, and methods described herein relate to a material including a first section including a first set of voids and a second section including a second set of voids at least partially filled with a substance such that the second section has a set of properties (e.g., mechanical and/or thermal properties) different from that of the first section. In some embodiments, the substance can include one or more of a viscous fluid, an elastic material, a viscoelastic material, a thermoplastic material, and/or a thermosetting material. In some embodiments, the set of properties that differs between the first section and the second section can include at least one of: a mechanical property (e.g., a strength, a stiffness, a ductility, a resonant frequency, a Poisson's ratio, and/or a modulus of elasticity) and/or a thermal property (e.g., a thermal capacitance, a thermal resistivity).

In an embodiment, an article comprises a material including: a first set of voids; and a second set of voids at least partially filled with a substance such that the second set of voids is inhibited from collapsing relative to the first set of voids, the first and second set of voids being distributed in different sections of the material such that the different sections of the material have different properties.

In an embodiment, an article comprises a material including: a first section including a first set of voids; and a second section including a second set of voids, the second set of voids at least partially filled with a substance such that the second set of voids is inhibited from collapsing relative to the first set of voids, the first and second sections having different properties such that the first section deforms differently from the second section.

In an embodiment, an article comprises a composite material including: a first material defining a set of voids; and a second material disposed in a first subset of voids such that the first subset of voids is inhibited from collapsing relative to a second subset of voids, the second material being different from the first material, the first subset of voids being distributed in a first layer of the material and the second subset of voids being distributed in a second layer of the material, such that the first and second layers of the material have different properties.

In an embodiment, a method comprises forming a material including a set of voids; and selectively delivering a substance to a first subset of voids distributed in a first section of the material such that (1) the first subset of voids is inhibited from collapsing relative to a second subset of voids distributed in a second section of the material and (2) the first and second sections having different properties.

### BRIEF DESCRIPTION OF THE DRAWINGS

FIG. 1 is a schematic diagram of a material having one or more voids, according to embodiments described herein.

FIG. 2A is a schematic diagram of an example material with different void characteristics along multiple dimensions, according to embodiments described herein.

FIGS. 2B and 2C depict cross-sectional views of the example material of FIG. 2A, taken along lines A-A′ and B-B′, respectively, as shown in FIG. 2A.

FIG. 3 depicts a side view or cross-sectional view of an example material including a plurality of voids, according to embodiments described herein.

FIGS. 4A-4C depict side views or cross-sectional views of an example, as a force is applied to the material, according to embodiments described herein.

FIG. 4D depicts a displacement-force profile associated with the force applied to the material as shown in FIGS. 4A-4C, according to embodiments described herein.

FIG. 5A depicts a side view or cross-sectional view of an example material, according to embodiments described herein. FIG. 5B depicts the material after displacing in response to a force being applied to the material.

FIG. 5C depicts a displacement-force profile associated with the force applied to the material shown in FIGS. 5A-5B, according to embodiments described herein.

FIG. 6A depicts a side view or cross-sectional view of an example material, according to embodiments described herein. FIG. 6B depicts the material after displacing in response to a force being applied to the material.

FIG. 6C depicts a displacement-force profile associated with the force applied to the material shown in FIGS. 6A-6B, according to embodiments described herein.

FIG. 7A depicts a side view or cross-sectional view of an example material, according to embodiments described herein. FIGS. 7B-7C depict the material after displacing in response to a force being applied to the material.

FIG. 7D depicts a displacement-force profile associated with the force applied to the material shown in FIGS. 7A-7C, according to embodiments described herein.

### DETAILED DESCRIPTION

Embodiments of the present disclosure are directed to materials having tunable properties (e.g., mechanical, thermal), and more specifically, materials including one or more voids that can be partially or completely filled with a substance (e.g., a solid material, a gel, a liquid, a gas, etc.) and/or have altered or tuned collapse behavior based on other mechanisms (e.g., mechanical structures, magnets, etc.). In some embodiments, a material may include a first section having one or more internal voids that can be at least partially filled with a substance to enable and/or facilitate selective adjustment or turning of one or more properties (e.g., mechanical and/or thermal) of the material. The substance in the internal voids is selected and/or engineered to affect one or more desired deformation or collapse behaviors of the material. In some embodiments, the material including one or more voids can be configured to enable those voids (or a subset of those voids) to be filled with a substance, e.g., via an internal vasculature system (e.g., a manifold, one or more channels, and the like). In some embodiments, the material can be designed to be elastically or plastically deformable, depending on the desired application. For example, in applications requiring cycling of multiple load and unload sequences, the material can be formed of an elastic material that can deform from an initial, unloaded configuration to a loaded configuration, and back to its unloaded configuration. Alternatively, in single use applications where the performance of the material is needed for one-time use, the material can be formed of a material designed to plastically deform (e.g., as in a structural safety feature of a mobile or stationary structure, such as a crumple zone, impact attenuator, or energy-dissipating or—directing feature of the mobile or stationary structure).

In some embodiments described herein, the material having one or more voids can have properties (e.g., mechanical and/or thermal) that are selectively tuned, e.g., tuned to have a particular tensile strength, for different applications. To that end, the embodiments of the present disclosure can provide materials useful in and across various industrial applications, including, for example, architectural design (e.g., for vibration, noise, and/or shock isolation), electronics packaging, vibration and shock isolation including the manufacture of vibration isolators and mounts for various industry sectors (e.g., manufacturing, automotive, aerospace, construction, civil infrastructure) where such isolators/mounts are used as interfaces between other components to diminish the transmission of shock and vibration, noise isolation, seat systems for comfort, ride quality, and/or occupant safety, and consumer product development for sound and vibration quality and long-life performance. Other advantages will be readily apparent to those skilled in the art in view of the present disclosure.

In some embodiments, the material may include a first section including a first set of voids and a second section including a second set of voids. The first section may have or be associated with a first set of properties (e.g., mechanical and/or thermal), and the second section having the second set of voids may be selectively and at least partially filled with a substance such that the second section has or is associated with a second set of properties (e.g., mechanical and/or thermal) different from the first set of properties. The voids may include, for example, internal cellular voids, porous structures, or architectures, and the like.

In some embodiments, the second set of voids may be at least partially filled with a substance to thereby affect a change in its macroscopic mechanical properties, such that the second section has or is associated with a second set of mechanical properties different from a first set of mechanical properties of the first section. For example, the first and second sections may respectively exhibit and be associated with displacement-force profiles, stress-strain curves, or stress-strain relationships that differ from one another based on a manner and degree of the at least partial filling of the second set of voids. The substance with which the second set of voids may be at least partially filled may include, for example, a viscous fluid, an elastic material, a viscoelastic material, a thermoplastic material, a thermosetting material, a liquid, a gas, or the like.

In some embodiments, the first section and the second section each have different mechanical properties. The mechanical properties may include, for example, strength, macroscopic bulk modulus or stiffness, ductility, hardness, impact resistance or attenuation, resonant frequency, Poisson's ratio, deformation or deflection, modulus of elasticity, and the like. In some embodiments, one or more of the mechanical properties may be or include, for example, anisotropic or directionally-dependent physical or mechanical properties.

In some embodiments, the first section and the second section each have different thermal properties. The thermal properties may include, for example, thermal capacitance, thermal resistivity, thermal expansion coefficient, thermal shock resistance, thermal diffusivity, etc.

In some embodiments, a composite material may include a first material defining a plurality of voids, and a second material different from the first material disposed in a set of the plurality of voids. The second material may be disposed in the set of voids such that a first section of the composite material including the set of voids has a first set of properties (e.g., mechanical, thermal) that is different than a second set of properties of a second section of the composite material.

In some embodiments, a method of manufacture of the material having the plurality of voids may include, for example, selectively delivering a substance to a set of voids of the first plurality of voids, such that the first section has a first set of properties that is different than a second set of properties of a second section of the material.

Advantageously, embodiments of the present disclosure can be implemented to provide materials that overcome drawbacks of existing materials, and further, enable or otherwise increase performance, utilization, durability, and control of and over the materials, such as in applications in which the materials are subjected to various static or dynamically applied loads, stresses, conditions, and constraints, among other factors, both during use and/or during transportation and/or storage. In particular, the materials can be selectively engineered, programmed, tuned, or otherwise configured to have certain properties, such as anisotropic or directionally-dependent mechanical properties and/or dynamic properties, suitable for use in applications requiring materials to withstand, resist, or support various, statically and/or dynamically applied loads, stresses, conditions, constraints, and other factors.

In some embodiments, the material can include sections having voids that can be selectively and at least partially filled with a substance. The voids of one or more of the sections can be at least partially filled to selectively adjust or tune the collapse behaviors or other properties of those sections of the material, based on a degree of the at least partial filling of the voids with the substance. For example, the first section can be configured to have an abrupt change in collapse behavior based on a degree of filling of voids in and of the first section, and the second section can be configured to have a smooth or progressive change in collapse behavior based on a degree of filling of voids in and of the second section. That is, the configurations (e.g. the at least partial filling of the voids) of the first and second sections may be such that each section exhibits a desired collapse behavior in response to one or more loads applied on the material. The characteristics of the voids, the filling of the void, and/or any directional change in the void characteristics and/or filling can be adjusted as desired to suit a wide range of different applications. Further, the materials described herein may be manufactured by way of various techniques, including, for example, molding (e.g., injection, foam, gas-assist), polymerization, casting, or three-dimensional printing.

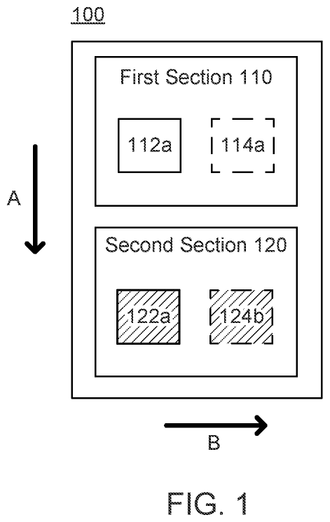

FIG. 1 is a schematic diagram depicting a cross sectional view of a material 100, according to an embodiment. As depicted, the material 100 includes a first section 110 and a second section 120, and optionally, a third section (not shown), a fourth section (not shown), and/or any number of sections (collectively, “material section(s)”). In some embodiments, the first section 110 can include a geometric element 112a and optionally a geometric element 112b (collectively, geometric elements 112). Moreover, the second section 120 can include a geometric element 122a and optionally a geometric element 122b (collectively, geometric elements 122). If the material includes additional sections (e.g., the third section and/or the fourth section), those sections can also include one or more geometric elements. The material 100 may have a height, a width, and a depth dimensioned along a z-axis, an x-axis, and an axis (not depicted) oriented normal to the z- and x- axes, such as depicted in FIG. 1.

In some embodiments, the geometric elements 112, 122 can be voids, e.g., a pore, microbubble, etc. The geometric elements 112, 122 can have or be associated with different characteristics or attributes, including different shapes, sizes, densities, etc. For example, the geometric elements 112, 122 can have a cross-sectional shape that is a circle or any polygonal shape (e.g., square, triangle, hexagon), with or without curved sides and/or corners. The geometric elements 112, 122 can vary in size, e.g., from a nanometer to meter scale, depending on the overall size and/or properties of the material 100. In some implementations, for example, a material (such as the material 100) that has larger dimensions can include voids with larger dimensions. In some implementations, the characteristics or attributes of the geometric elements 112, 122 can be selected based on a specific application (e.g., to achieve a specific set of mechanical and/or thermal properties, such as a specific displacement-force profile, macroscopic bulk modulus or stiffness, Poisson's ratio, anisotropic property, or other property).

One or more of the geometric elements 112, 122 when implemented as voids, can be configured to be filled partially or completely with a substance (e.g., a second material, such as a solid, liquid, gel, gas, etc.) to tune the properties (e.g., different displacement-force profiles, macroscopic bulk moduli or stiffness, Poisson's ratios, anisotropic properties, thermal properties) of the sections 110 and/or 120, respectively. For example, one or more of the voids 112, 122 can be filled with a substance to change their collapse behavior, and to thereby change the properties of the respective sections 110 and/or 120, respectively. Alternatively or additionally, the behavior of one or more of the voids 112 and/or 122 can be altered using other mechanisms, e.g., mechanical structures (e.g., a supporting element such as a beam or wire), one or more magnets, etc. By selectively filling one or more of the voids 112 and/or 122, the properties of the material 100 can be engineered or tuned for use in specific applications. The voids 112 and/or 122 can have constant and/or varying geometry along one or more cross-sections of the material 100. In some embodiments, the voids 112 and/or 122 can have characteristics (e.g., shape, size) that vary in one or more directions. In some embodiments, the material 100 can have a gradient or directional variation in material properties, such as a directional variation in void characteristics of one or more of the voids 112 and/or 122, similar to that disclosed in International Patent Application No. PCT/US2019/063070, filed Nov. 25, 2019, titled “Materials Having Graded Internal Geometry, And Associated Systems And Methods,” incorporated herein by reference.

The material 100 can be manufactured using techniques including, for example, molding (e.g., injection, foam, gas-assist), polymerization, casting, three-dimensional printing, or the like. The filling of the voids 112 and/or 122 may be conducted, e.g., using active approaches, semi-active approaches, passive approaches, or by other suitable approaches. For example, in some embodiments, the material 100 can have voids that have three-dimensional architectures that can be filled with one or more substances, e.g., using channels or passageways (e.g., an internal vasculature) that connects to the voids. In some embodiments, for example, the material 100 can include a manifold or network of channels configured to convey and deliver a substance through a portion of the material 100 to one or more voids (e.g., geometric elements 112 and/or 122). The material 100 can be formed with these channels (e.g., during injection molding), or these channels can be added to the material 100 after the material 100 is formed (e.g., using mechanical, chemical, and/or electrical mechanisms or material removal or ablation techniques).

In some embodiments, the material 100 can have voids (e.g., geometric elements 112 and/or 122), or channels connected to the voids, that extend through a portion of the material 100, such that the voids can be filled with a substance via an end of the void or channel, which may include an opening or inlet disposed along a surface of the material 100. In some embodiments, the material 100 can be constructed in layers, e.g., via 3D printing and/or other manufacturing processes, to have voids and/or substances disposed at discrete locations within the material 100.

In some implementations, the substance used to fill one or more of the voids (e.g., geometric elements 112 and/or 122) may include, for example, a fluid, a gas, a gel, a solid, or combinations thereof. For example, the substance can include a viscous fluid (e.g., a liquid or gas), an elastic material, a viscoelastic material, a thermoplastic material, or a thermosetting material. The substance can be used to selectively adjust at least one property (e.g., mechanical, thermal) of the material 100 via filling of the voids of one or more of the sections 110 and/or 120, in accordance with embodiments of the present disclosure. For example, the substance can be used to fill a void to change the collapse properties of the void (e.g. inhibit the collapse of the void), and therefore, to change the collapse properties of a section (e.g., section 110, section 120) of the material 100 that includes the filled void or in which the filled void is situated.

The voids of the geometric elements 112 and/or 122 can be individually and at least partially filled with the substance to obtain dynamic properties desirable for different applications of the material 100. For example, the mechanical and/or thermal properties of the material 100 can be tuned, e.g., via the filling of one or more voids (e.g., geometric elements 112 and/or 122, etc.) with the substance, to affect desired performance attributes of the material 100, such as for applications including, for example, architectural design (e.g., for vibration, noise, and/or shock isolation), electronics packaging and padding, impact attenuation or vibration and shock isolation, such as in the manufacture of impact attenuators (e.g., crumple zones) or vibration isolators and mounts for various industry sectors (e.g., manufacturing, automotive, transportation, aerospace, construction, civil infrastructure, etc.) where such attenuators/isolators/mounts are used as interfaces between other components to direct, dissipate, or diminish the transmission of energy, shock, and/or motion or vibration, noise isolation, seat systems for comfort, ride quality, and/or occupant safety, and consumer product development for sound and vibration quality and long-life performance. The voids can be filled with a substance to change (e.g., by inhibiting, preventing, or otherwise selectively adjusting) their collapse behavior, by altering the mechanical and/or thermal properties of one or more of the sections (e.g., sections 110 and/or 120) of the material 100. The extent of the selective change or adjustment of a property may depend on the type of substance being used to fill the void, an amount of filling (e.g., 50%, 100%), or an amount of the substance being used to fill the void, characteristics of the void (e.g., shape, size), etc.

In some embodiments, the material 100 and/or substances used to fill one or more voids of the material 100 can be elastically and/or plastically deformable, depending on the desired application. For example, in applications requiring resistance to cycling of multiple load and unload sequences, the material 100 and/or the substances can be formed of an elastic material that can deform from an initial, unloaded configuration to a loaded configuration, and back to its unloaded configuration. Alternatively, in single use applications where the performance of the material 100 is required to withstand one-time use, the material 100 and/or the substances can be formed of a plastically deformable material. Examples of suitable materials include foams, elastomers, natural or organic material, polymers, composites, alloys, and metals.

In some embodiments, the geometric elements 112a and 112b can be implemented as discrete voids. Similarly, the geometric elements 122a and 122b can also be implemented as discrete voids. Each individual void can be filled with any suitable substance (e.g., a fluid, a gas, a gel, a solid, etc.), in accordance with embodiments of the present disclosure. One or more of the geometric elements 112a and/or 112b can have characteristics that are similar to or different from those of the geometric elements 122a and/or 122b. For example, the geometric elements 112a112b, 122a, and 122b can have the same size and/or shape or different sizes and/or shapes.

Optionally, in some embodiments, the material 100 can include additional sections (e.g., such as the sections 110 and/or 120) that each respectively include one or more geometric elements (e.g., such as the geometric elements 112 and/or 122), which may be implemented as voids and/or filled with a substance. For example, in some embodiments, the material 100 can include a third section that includes one or more geometric elements that are implemented as voids, a fourth section that includes one or more geometric elements that are implemented as voids, and so on. The third and fourth sections and/or any other additional sections can be configured in a manner such as described with respect to the geometric elements 112 and/or 122 of the first and second sections 110 and/or 120. The geometric elements of the additional sections can have characteristics that are similar to or different from those of the geometric elements 112 and/or 122. For example, one or more of the geometric elements of one or more of the additional sections of the material 100 can be filled with a substance that is the same as or different from the substance used to fill one or more of the geometric elements 112 and/or 122. In some embodiments, the material 100 can include one or more sections (e.g., sections 110 and/or 120) that include voids that are not filled with a substance, while other sections of the material 100 can include voids that are filled with a substance.

The first section 110 can have a first set of properties (e.g., mechanical, thermal), and the second section 120 can have a second set of properties that are different from the first set of properties. Examples of properties include mechanical properties such as strength, macroscopic bulk modulus or stiffness, ductility, hardness, impact resistance, Poisson's ratio, deformation, etc., and/or thermal properties such as thermal conductivity and thermal resistance. The properties can be isotropic or anisotropic (e.g., properties that vary with orientation). Each section of the material 100 (e.g., 110, 120) may have properties that are dependent at least in part on characteristics or attributes of one or more of their respective geometric elements 112 and/or 122. In some embodiments, for example, if a force is applied to the material 100, such as in direction A as depicted in FIG. 1—such that both the first section 110 and the second section 120 are subjected to the force—then the material 100 may be configured to deform according to a displacement-force profile based on a combined deformation or collapse behavior of the first section 110 and the second section 120. For example, the displacement-force profile can have (i) a first region with a displacement-force relationship associated with a collapse behavior of one or more of the geometric element(s) 112a, 112b of the first section and (ii) a second region with a displacement-force relationship associated with a collapse of the geometric element(s) 122a, 122b of the second section 120. By adjusting the characteristics of the geometric element(s) 112a, 112b of the first section 110 and the geometric element(s) 122a, 122b of the second section 120, a number or density of geometric element(s) in sections 110, 120, substance(s) used to fill those geometric elements, and/or other material properties, the properties of the material 100 can be adjusted or tuned, accordingly, to suit the material 100 for use in different applications.

Optionally, in some embodiments, if the material 100 includes additional sections (e.g., in addition to the sections 110 and 120), the properties of the material 100 can be tuned by adjusting the characteristics of the geometric elements of the additional sections, such as by filling those geometric elements with one or more substance(s) to adjust or tune the material properties of the additional sections in a manner similar to that described with respect to the first and second sections 110 and 120. For example, a third section (not depicted) of the material 100 can have a third set of properties (e.g., different from the properties associated with the first section 110 and/or the second section 120) that depends on characteristics of geometric elements and/or substance(s) used to fill the geometric elements of the third section. Moreover, a fourth section (not depicted) can have a fourth set of properties (e.g., different from the properties associated with the first section 110, the second section 120, and/or the third section) that depends on characteristics of geometric elements and/or substance(s) used to fill the geometric elements of the fourth section.

In some embodiments, one or more of the sections 110 and/or 120 can have material properties that are anisotropic (i.e., directionally dependent). For example, the first section 110 may have an anisotropic mechanical property such as an anisotropic collapse behavior in which the section 110 may collapse or deform to a greater extent when a force is applied to that section, such as in the direction A, when compared to that same force being applied to that section such as in a direction B as depicted in FIG. 1.

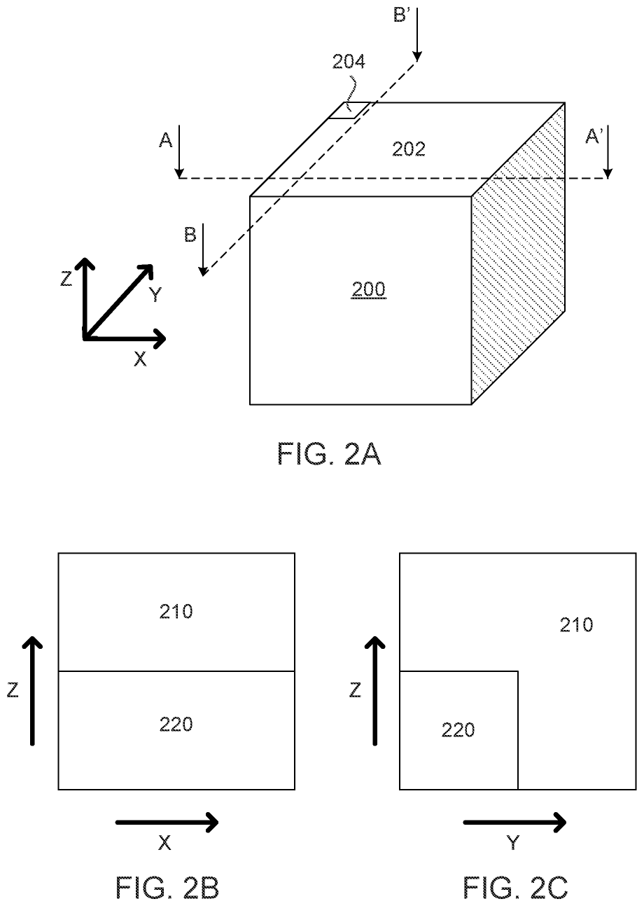

FIG. 2A is a schematic diagram depicting a perspective view of a material 200, according to an embodiment. The material 200 is schematically depicted as having a cuboid or box-shaped structure; however, it should be understood that the material 200 can have any three-dimensional shape or configuration, including, for example, a pyramidal shape, a cylindrical shape, a conical shape, a spherical shape, etc. The material 200 can have component(s) that are functionally and/or structurally similar to those of the material 100 and/or other materials described herein. For example, the material 200 can have different sections having different material properties and/or internal geometric elements.

FIGS. 2B and 2C are schematic diagrams depicting cross-sectional views of the material 200 of FIG. 2A, taken along lines A-A′ and B-B′, respectively, as shown in FIG. 2A. Specifically, FIG. 2B depicts a cross-sectional view of the material 200 as taken along line A-A′, and FIG. 2C depicts a cross-sectional view of the material 200 as taken along line B-B′. As depicted in FIG. 2B, the material 200 can have a plurality of material sections 210, 220 each having internal geometric elements such as, for example, voids. The geometric elements of each section 210, 220 can have similar or different characteristics. For example, the section 210 can have voids having a shape and/or size different form that of the section 220. In some embodiments, one or more of the voids can be partially or completely filled with a substance, e.g., a gas, a liquid, a solid material (e.g., an elastic material), etc. In some implementations, properties (e.g., a displacement-force profiles, collapse behavior, Poisson's ratio, anisotropic properties, thermal properties, etc.) of the section 210 may depend at least in part on the characteristics of the geometric element(s) (e.g., a shape, size, density, etc. of the geometric elements) and/or the substance(s) used to fill the geometric element(s), and properties of the section 220 may depend at least in part on the characteristics of the geometric element(s) and/or the substance(s) used to fill the geometric element(s). In such implementations, the properties may vary in or across the material sections 210, 220 according to changes in the characteristics of the geometric element(s) in each section 210, 220, and/or substance(s) used to fill those geometric element(s).

In some embodiments, the section 210 can include voids that are not filled with a substance while the section 220 can include voids that are filled with a substance to thereby affect a change in the one or more macroscopic properties of the section 220, such that the section 220 has or is associated with a set of properties that is different from a set of properties of the section 210. In some embodiments, the section 210 can include voids that are filled with a first substance and the section 220 can include voids that are filled with a second substance that is different from the first substance, such that the section 220 can have material properties that differ from the section 210. While the material 200 as depicted in FIGS. 2B and 2C is illustrated as having two material sections 210, 220, it can be appreciated that the material 200 can have any number of material sections that can extend in one or more directions through the material 200, as shown in FIGS. 2B and 2C.

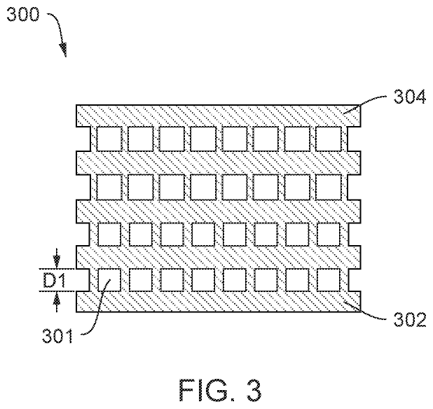

With reference to FIG. 2A, when a local uniaxial force is applied in a direction perpendicular to a surface 202 of the material 200 above an area 204, the material 200 may exhibit behavior based on the characteristics of the geometric elements of the material section below the surface 202 of the area 204. As further described below with reference to FIGS. 3-7D, external forces applied to areas of the material 200 can exhibit one or more sudden changes in properties (e.g., sudden reductions in macroscopic stiffness), with deviations to such properties effectuated by selective filling of one or more voids (e.g., geometric elements) in the material. In an embodiment, the material 200 when subjected to a uniaxial load can deform according to a displacement-force profile including one or more regions with a sudden collapse trend and one or more regions with a linear deformation trend (e.g., have a first region with a linear deformation trend, followed by a region with a sudden collapse trend, and then followed by a second region with a linear deformation trend). The external forces applied to the materials described herein may include, for example, displacements, loads, stresses, strains, or boundary conditions that give rise to deformation of the material and its associated internal geometric elements.

In some implementations, a material (e.g., material 100, 200) having one or more of the voids may have, for example, a cross section having a matrix or honeycomb structure. The material may be configured and implemented with respect to a structure to suppress, damp, or isolate vibrations between that structure and the environment or other structures in the environment (e.g., a ground or wall).

FIG. 3 depicts a side view of a material 300, according to an embodiment. The side view of FIG. 3 can be representative of a cross-sectional view of the material 300. The material 300 can have component(s) that are functionally and/or structurally similar to those of materials 100, 200 and/or other materials described herein. For example, the material 300 can have a first side 302 and a second side 304, and include geometric elements implemented in the form of voids 301. The material 300 can be formed from an elastically or plastically deformable material, e.g., depending on the desired application.

The voids 301 can have a rectangular or square cross-sectional shape, and have a lateral dimension D1. The voids 301 can be disposed uniformly (e.g., at set distances or intervals from one another) within the material 300. The voids 301 can be unfilled, e.g., filled with atmospheric air and not filled with a substance designed to alter a collapse behavior of the void (e.g., a substance designed to inhibit a collapse of the void). While the material 300 is shown and described as having a rectangular cross-sectional profile, with voids having a rectangular cross-sectional profile, it can be appreciated that the material 300 can have any suitably shaped cross-sectional profile (e.g., triangular, circular, etc.), with voids having any suitable shape and/or size, in accordance with embodiments of the present disclosure. In some embodiments, the material 300 can include voids with different characteristics, voids having an ordered or disordered arrangement, etc., as described in International Patent Application No. PCT/US2019/063070, incorporated by reference herein.

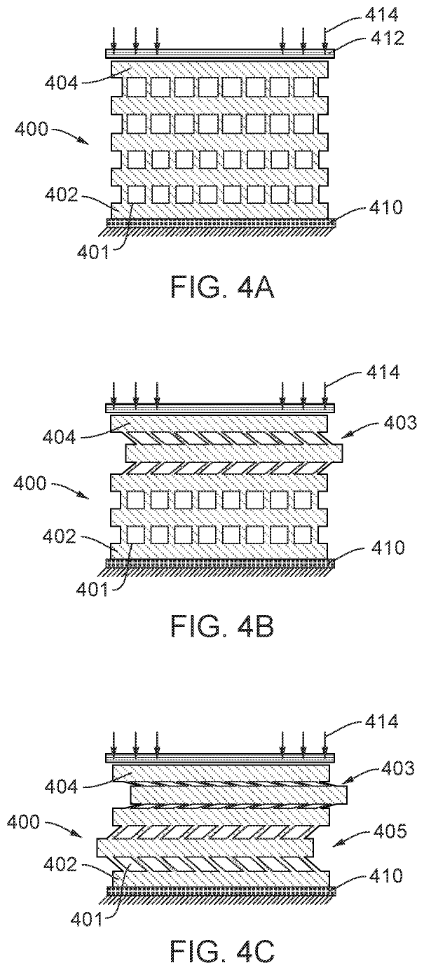

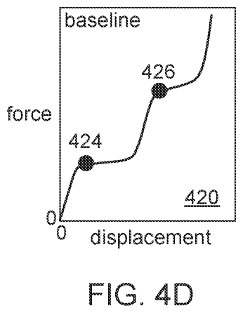

FIGS. 4A-4C depict a load 414 being applied to a side 404 of a material 400, according to an embodiment. The material 400 can be functionally and/or structurally similar to the material 300, and/or any of the other materials (e.g., 100, 200) as described herein. Materials 300, 400 are referred to herein as “baseline” materials, i.e., a material with voids that are unfilled and therefore not tuned to have specific properties (e.g., mechanical, thermal). The material 400 can include individual geometric elements in the form of voids 401, and have a first side 402 and a second side 404. The voids 401 can be unfilled, e.g., not include any substance that reduces or inhibits a collapse of the voids 401. The load 414 may include, for example, an externally applied load or force. For illustration and explanation purposes, the material 400 is depicted as being positioned on a flat surface 410 that is represented as not moving or compressing in response to the application of the external load 414 to the material 400, and the external load 414 is depicted as being an uniaxial load that is evenly applied (e.g., via a plate 412 or other flat structure) across the side 404 of the material 400 (e.g., a top surface of the material 400). While the surface 410 and the plate 412 are depicted as flat, smooth structures, it can be appreciated that material 400 can be used in applications with other surface profiles (e.g., a curved, textured, and/or angled surface). Examples of displacement applications such as that depicted in FIGS. 4A-4C can be for supporting a structure (e.g., a machine component) to prevent passage of vibration from the structure to another structure (e.g., a fixed ground or other machine component).

As shown in FIGS. 4A-4C, when the load 414 is applied, the material 400 may deform and successively transition between different states, each associated with a macroscopic change in one or more material properties of the material 400. For example, each state can be associated with a sudden reduction in macroscopic stiffness. The material 400 can displace according to a displacement-force profile 420, as depicted in FIG. 4D. The displacement-force profile 420 can have a first region with a linear relationship (e.g., associated with a linear elastic state), followed by a point 424 at which a first set of voids 403 (e.g., voids near the side 404 of the material 400) collapse, then followed a second region with a linear relationship (e.g., associated with a linear elastic state), and then followed by a point 426 at which a second set of voids 405 (e.g., voids near the side 402 of the material 400) collapse. After the first set of voids 403 and the second set of voids 405 have collapsed (i.e., the boundaries defining the voids have self-contacted), the material 400 can again exhibit a linear displacement-force relationship (e.g., associated with a linear elastic state or a hardened state), as additional force is applied. The points 424, 426, where the first set of voids 403 and the second set of voids 405 collapse, respectively, can be associated with the different states at which the material 400 exhibits a sudden reduction in macroscopic stiffness.

The displacement-force profile 420 depicted in FIG. 4D can be representative of, for example, a displacement-force profile of a material having uniformly disposed voids 401 in which the voids 401 are not filled with a substance that alters the collapse behavior of the voids 401.

While FIG. 4D depicts that the stiffness (i.e., slope of the displacement-force profile) of the material 400 can change with increasing application of force, those of skill in the art will appreciate that the material 400 can exhibit or have other mechanical properties that may change based on the specific microstructure of the material 400 and/or other properties such as thermal properties. For example, the material 400 can have changes in mechanical properties including, for example, Poisson's ratio, an anisotropic property, etc., as described herein.

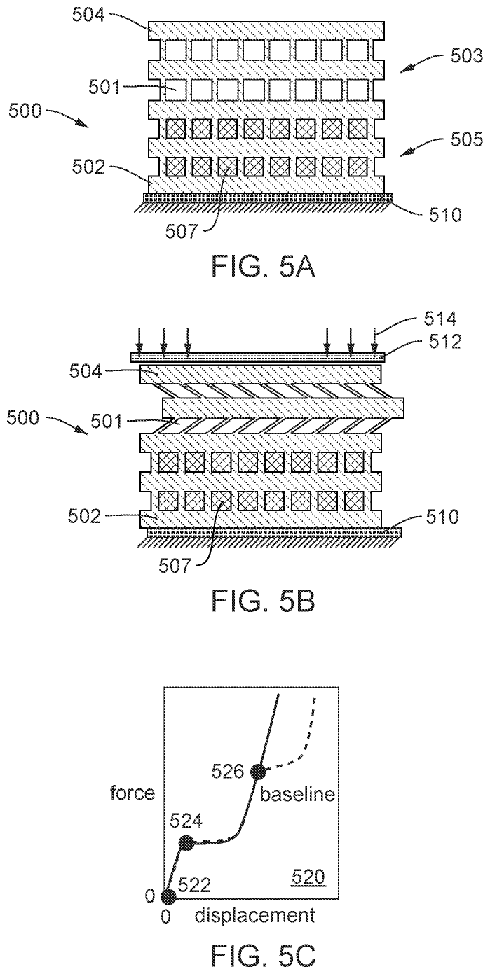

One of more voids of a material (e.g., material 100, 200, 300, 400) can be filled in any suitable manner to selectively adjust or tune the properties (e.g., mechanical, thermal) of the material, as described herein. For example, as depicted in FIGS. 5A-5B, a set of voids 505 of a material 500 can be filled with a substance 507 to adjust the mechanical properties of the material 500. FIG. 5A provides a side or cross-sectional view of the material 500, and FIG. 5B depicts a side or cross-sectional view of the material 500, as the material 500 is subjected to a load 514, according to embodiments described herein.

The material 500 can have component(s) that are functionally and/or structurally similar to other materials described herein. For example, the material 500 can be functionally and/or structurally similar to the material 400, except that the set of voids 505 near a bottom surface 502 of the material 500 can be filled with the substance 507. As depicted, the material 500 includes geometric elements in the form of voids 501, and has a first side 502 and a second side 504. The material 500 can have a first section including a first set of voids 503 and a second section including a second set of voids 505. The second set of voids 505 (i.e., voids closer to the side 502 of the material 500, or closer to a bottom of the material 500) can be filled with a substance 507, such as described with reference to FIG. 1. For example, in some implementations, the second set of voids 505 can be filled with any suitable solid, liquid, or gas (or combination thereof), as described herein, to change a collapse behavior of the second set of voids 505 and therefore the second section of the material 500 (e.g., the bottom layers of the material 500). It may be desirable to change the collapse behavior of the second set of voids 505 to suit various applications, e.g., supporting a structure (e.g., a machine component) to prevent passage of vibration from the structure to another structure (e.g., a fixed ground or other machine component).

The load 514 may include, for example, an externally applied load or force. For illustration and explanation purposes, the material 500 is depicted as being positioned on a flat surface 510 that is represented as not moving or compressing in response to the application of the external load 514 to the material 500, and the external load 514 is depicted as being an uniaxial load that is evenly applied (e.g., via a plate 512 or other flat structure) across the side 504 of the material 500 (e.g., a top surface of the material 500). While the surface 510 and the plate 512 are depicted as flat, smooth structures, it can be appreciated that the material 500 can be used in applications with other surface profiles (e.g., a curved, textured, and/or angled surface).

In some implementations, the substance 507 by which the second set of voids 505 may be at least partially filled may be configured to inhibit or prevent a collapse or deformation of the one or more voids, so as to thereby achieve a desired mechanical property. The substance 507 may be any suitable substance for affecting a selective adjustment of one or more mechanical properties of the material (e.g., as such may relate to behaviors such as a deformation, collapse, elastic or plastic mechanical response, etc.) with respect to an application of use, in accordance with embodiments of the present disclosure. Accordingly, the second set of voids 505 of the material may be at least partially filled with the substance so as to affect a desired deformation or collapse behavior of the material in response to an applied load. As an example, the at least partial filling of the second set of voids 505 with the substance 507 may be configured to inhibit or substantially prevent an occurrence of a macroscale collapse or deformation behavior of the material by inhibiting or substantially preventing microscale collapse behavior of the at least partially filled the voids 501. In other words, the inability of the bottom layers of the material 500 to collapse due to the at least partial filling of the second set of voids 505 causes a portion of the mechanical properties of the material to be realized when compared to a material having voids that are unfilled (e.g., material 400 as depicted in FIGS. 4A-4C, with a displacement-force profile as depicted in FIG. 4D).

FIG. 5C depicts a displacement-force profile 520 of the material 500, with increasing application of the load 514. The displacement-force profile 520 can have a first region with a linear displacement-force relationship (e.g., associated with a linear elastic state of the material 500) between points 522 and 524. Point 524 can be associated with a sudden collapse of the first set of voids 503 that are not filled with the substance 507. Once the first set of void 503 have collapsed, contact between the boundaries defining the first set of voids 503 can cause the material 500 to exhibit a displacement-force profile that is once again linear (e.g., such as a linear relationship associated with a linear elastic state or a hardened state), as additional force is applied.

FIG. 5C depicts the displacement-force profile 520 of the material 500 against the displacement-force profile 420 of the material 400 (i.e., baseline material) depicted in FIGS. 4A-4C. As depicted in FIG. 5C, up until point 526, the displacement-force profile of the material 500 can be similar to the displacement-force profile of the material 400 (as illustrated in dashed lines in FIG. 5C, and illustrated similarly in FIG. 4D). Beyond point 526, however, the material 500 continues to exhibit a linear displacement-force relationship, while the material 400 undergoes a sudden collapse (e.g., due to a collapse of the second set of voids 405). Since the second set of voids 505 of the material 500 are filled, the material 500 does not undergo this sudden collapse. This inability of the second section (e.g., bottom layers) of the material 500 to collapse causes a portion of the mechanical properties of the material 500 to be realized when compared the material 400. Therefore, the mechanical properties of the material 500 have been altered from that of the material 400 by selectively filling the second set of voids 505 of the material 500.

While FIGS. 5A-5B depict that different sections of the material 500 (e.g., a first section including a first set of voids 503 that are unfilled and a second section including a second set of voids 505 that are filled) can have stiffness (i.e., as represented by the slope of their respective displacement-force profiles) that changes as a load is applied, those of skill in the art will appreciate that the material 500 and/or various sections of the material 500 can have other properties (e.g., mechanical, thermal) that may change based on the specific microstructure of the material 500. For example, different sections of the material 500 can have changes in mechanical properties including, for example, Poisson's ratio, an anisotropic property, etc.

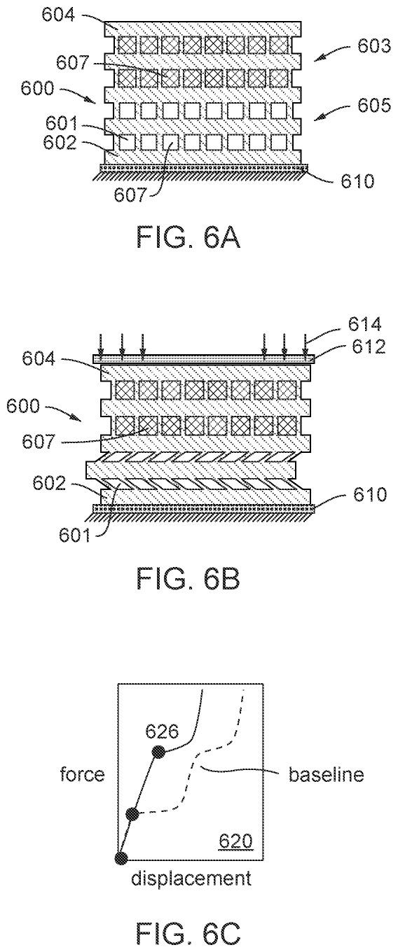

In an alternative embodiment, as depicted in FIGS. 6A-6B, a set of voids 603 of a material 600 can be filled with a substance to adjust the mechanical properties of the material 600. The set of voids 603 can be closer to a surface on which a load (e.g., a load 614) is being applied (e.g., a top surface 604 of the material 600) than the set of voids 505 of the material 500. FIG. 6A provides a side or cross-sectional view of the material 600, and FIG. 6B depicts a side or cross-sectional view of the material 600, as the material 600 is subjected to a load 614, according to embodiments described herein.

The material 600 can have component(s) that are functionally and/or structurally similar to other materials described herein. For example, the material 600 can be functionally and/or structurally similar to the material 400, except that the set of voids 603 near a top surface 604 of the material 600 can be filled with the substance 607. As depicted, the material 600 includes geometric elements in the form of voids 601, and has a first side 602 and a second side 604. The material 600 can include a first section with the set of voids 603 and a second section including a set of voids 605. In some implementations, a first set of voids 603 may be at least partially filled with a substance 607 (e.g., a solid material, a liquid, a gas, etc.).

The load 614 may include, for example, an externally applied load or force. For illustration and explanation purposes, the material 600 is depicted as being positioned on a flat surface 610 that is represented as not moving or compressing in response to the application of the external load 614 to the material 600, and the external load 614 is depicted as being an uniaxial load that is evenly applied (e.g., via a plate 612 or other flat structure) across the side 604 of the material 600 (e.g., a top surface of the material 600). While the surface 610 and the plate 612 are depicted as flat, smooth structures, it can be appreciated that the material 600 can be used in applications with other surface profiles (e.g., a curved, textured, and/or angled surface).

The set of voids 603 may be filled at least partially with a substance, such as that described with reference to material 100 and other materials disclosed herein, to change the mechanical properties of the set of voids 603 (e.g., to inhibit collapse of the top layers) in response to an load applied to the material 600. FIG. 6C depicts the displacement-force profile 620 of the material 600, as the load 614 is applied to the material 600. As depicted, the displacement-force profile 620 of the material 600 differs from the displacement-force profile of the material 400 (as illustrated in dashed lines in FIG. 6C, and illustrated similarly in FIG. 4D). From point 622 to 624, the material 600 exhibits a linear displacement-force relationship. At point 624 (or corresponding point 424, as depicted in FIG. 4D), the material 400 exhibits a sudden collapse associated with the collapse of the first set of voids 403 of the material 400. Since the first set of voids 603 of the material 600 are filled with a substance such that their collapse behavior is inhibited, the displacement-force profile 620 of the material continues to have a linear force-displacement relationship until a point 626. At point 626, the material 600 exhibits a sudden collapse associated with the sudden collapse of the second set of voids 605. Beyond the collapse, contact between the boundaries defining the second set of voids 605 can cause the material 600 to exhibit a displacement-force profile that is once again linear (e.g., such as a linear relationship associated with a linear elastic state or a hardened state), as additional force is applied.

While FIG. 6C depicts that the material 600 can have different stiffness (e.g. as represented by the slope of its displacement-force profile) as a force is applied to the material 600, those of skill in the art will appreciate that the material 600 and/or various sections of the material 600 can have other properties (e.g., mechanical, thermal) that may change based on the specific microstructure of the material 600. For example, different sections of the material 600 can have changes in mechanical properties including, for example, Poisson's ratio, an anisotropic property, etc.

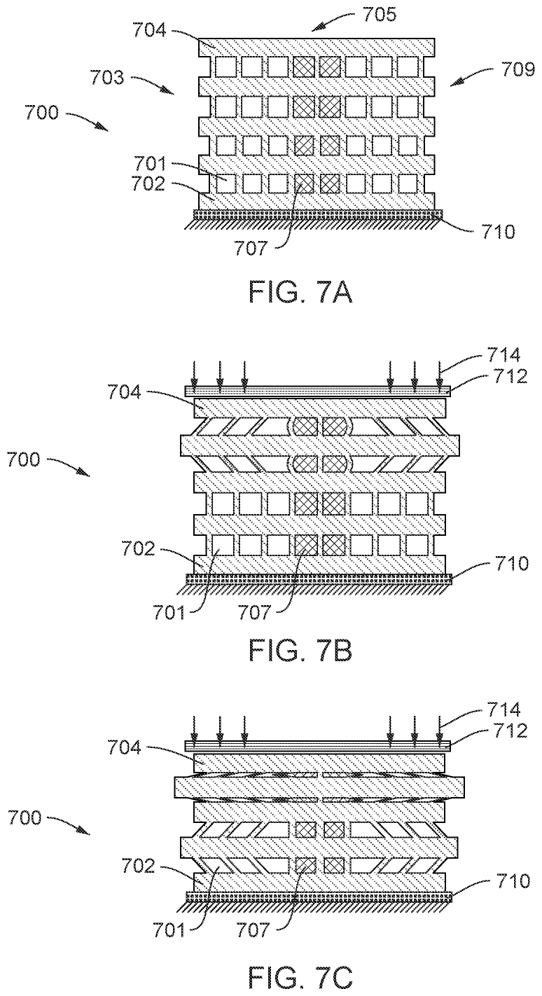

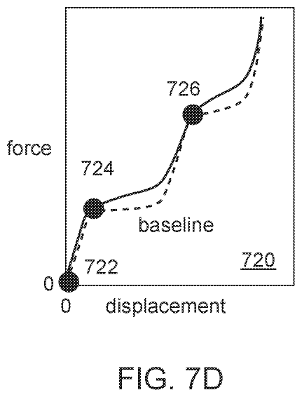

FIGS. 7A-7C depict cross sectional views of a material 700 subject to a load 714, according to embodiments disclosed herein. As depicted, the material 700 may include individual geometric elements in the form of voids 701, and have a first side 702 and a second side 704. In some implementations, one or more of the voids 701 may be at least partially filled with a substance 707, such as described with reference to FIG. 1.

The material 700 can have component(s) that are functionally and/or structurally similar to other materials described herein. For example, the material 700 can be functionally and/or structurally similar to the material 400, except that one or more voids 701 of the material 700 can be filled with the substance 707. As depicted, the material 700 can include a first section including a first set of voids 703, a second section with a second set of voids 705, and a third section with a third set of voids 709. The second set of voids 705 can be filled at least partially with a substance 707 (e.g., a solid material, a liquid, a gas, etc.).

The load 714 may include, for example, an externally applied load or force. For illustration and explanation purposes, the material 700 is depicted as being positioned on a flat surface 710 that is represented as not moving or compressing in response to the application of the external load 714 to the material 700, and the external load 714 is depicted as being an uniaxial load that is evenly applied (e.g., via a plate 712 or other flat structure) across the side 704 of the material 700 (e.g., a top surface of the material 700). While the surface 710 and the plate 712 are depicted as flat, smooth structures, it can be appreciated that material 700 can be used in applications with other surface profiles (e.g., a curved, textured, and/or angled surface).

The set of voids 705 (e.g., a central set of voids) may be filled at least partially with a substance, such as that described with reference to material 100 and other materials disclosed herein, to change the mechanical properties of the set of voids 705 (e.g., to inhibit collapse of the top layers) in response to an load applied to the material 700. FIG. 7D depicts the displacement-force profile 720 of the material 700, as the load 714 is applied to the material 700. Because the set of voids 705 are filled with a substance, the material 700 exhibits a first collapse associated with the collapse of the top layers of the material 700 (FIGS. 7B and 7C) and a second collapse associated with the collapse of the bottom layers of the material 700, but not as sudden as (e.g. more progressive than or with greater slope than) that exhibited by the material 400 (e.g., the baseline material). Therefore, as depicted in FIG. 7D, where the displacement-force profile 420 of the material 400 is shown in dashed lines and the displacement-force profile 720 of the material 700 is shown in a solid line, the collapse trends of the material 700 are less sudden than the collapse trends of the material 400.

As depicted, the displacement-force profile 720 can have an initial linear displacement-force relationship (e.g., associated with a linear elastic state of the material 700) between points 722 and 724. Following point 724, the displacement-force profile 720 can have a region of lesser slope associated with a collapse of the top layers and voids of the material 700 (i.e., the layers and voids closer to the surface 704), followed by a subsequent linear displacement-force relationship (e.g., associated with a linear elastic state of the material 700). Following point 726, the displacement-force profile 720 can have a region of lesser slope associated with a collapse of the bottom layers and voids of the material 700 (i.e., the layers and voids closer to the surface 702). Beyond the collapse of the voids 701, contact between the boundaries defining the voids 701 can cause the material 700 to exhibit a displacement-force profile that is once again linear (e.g., such as a linear relationship associated with a linear elastic state or a hardened state), as additional force is applied.

While FIG. 7D depicts that the material 700 can have different stiffness (e.g. as represented by the slope of its displacement-force profile) as a force is applied to the material 700, those of skill in the art will appreciate that the material 700 and/or various sections of the material 700 can have other properties (e.g., mechanical, thermal) that may change based on the specific microstructure of the material 700. For example, different sections of the material 700 can have changes in mechanical properties including, for example, Poisson's ratio, an anisotropic property, etc.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; and that embodiments may be practiced otherwise than as specifically described and claimed without departing from the scope and spirit of the present disclosure. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope and spirit of the present disclosure.

Also, various concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. An article, comprising:
a material including:
a first section including a first set of voids; and
a second section including a second set of voids, the second set of voids at least partially filled with a substance such that the second set of voids is inhibited from collapsing relative to the first set of voids,
the first and second sections having different properties such that the first section deforms differently from the second section.

2. The article of claim 1, wherein, in response to an increasing unidirectional force being applied to a surface of the material closer to the first section than the second section, the material is configured to deform according to a displacement-force profile that has a region of near-zero slope representing a sudden collapse of the first set of voids followed by a region of positive slope representing linear displacement of the material in proportion to the force.

3. The article of claim 1, wherein, in response to an increasing unidirectional force being applied to a surface of the material closer to the second section than the first section, the material is configured to deform according to a displacement-force profile that has a region of positive slope representing linear displacement of the material in proportion to the force followed by a region of near-zero slope representing a sudden collapse of the first set of voids.

4. The article of claim 1, wherein, in response to an increasing unidirectional force being applied to a surface of the material that extends along a boundary of the first and second sections, the material is configured to deform according to a displacement-force profile that has a region of constant positive slope representing linear displacement of the material in proportion to the force followed by a region of changing positive slope representing a progressive collapse of a subset of the first set of voids.

5. The article of claim 1, wherein the substance includes at least one of: a viscous fluid, an elastic material, a viscoelastic material, a thermoplastic material, or a thermosetting material.

6. The article of claim 1, wherein the different properties include at least one of: strength, stiffness, ductility, resonant frequency, Poisson's ratio, modulus of elasticity, or a thermal property.

7. The article of claim 1, wherein the material is an elastic material such that the material is configured to deform from an unloaded configuration to a loaded configuration in response to the force being applied to the material and to revert back to the unloaded configuration after the force is not being applied.

8. The article of claim 1, wherein the material is a plastic material such that the material is configured to deform from an unloaded configuration to a loaded configuration in response to the force being applied to the material and to remain in the loaded configuration after the force is not being applied.

9. The article of claim 1, wherein the first set of voids has a different geometric shape than the second set of voids.

10. The article of claim 9, wherein the first set of voids has a maximum lateral dimension that is greater than that of the second set of voids.

11. The article of claim 9, wherein the first set of voids has a different cross-sectional shape than the second set of voids.

12. The article of claim 1, wherein each void of the first and second sets of voids extends across a lateral length of the material.

13. The article of claim 1, wherein each of the second set of voids is completely filled with the substance such that the second set of voids is prevented from collapsing in response to a force being applied to the material.

14. An article, comprising:
a composite material including:
a first material defining a set of voids; and
a second material disposed in a first subset of voids such that the first subset of voids is inhibited from collapsing relative to a second subset of voids, the second material being different from the first material,
the first subset of voids being distributed in a first layer of the material and the second subset of voids being distributed in a second layer of the material, such that the first and second layers of the material have different properties.

15. The article of claim 14, wherein each of the set of voids has the same cross-sectional shape and extends across a lateral length of the composite material.

16. The article of claim 14, wherein the different properties include at least one of: strength, stiffness, ductility, resonant frequency, Poisson's ratio, modulus of elasticity, or a thermal property.

17. The article of claim 14, wherein:
the first and second layers extend parallel to a surface of the composite material, the second layer being closer to the surface, and
in response to an increasing unidirectional force being applied to the surface, the composite material is configured to deform according to a displacement-force profile that has a region of near-zero slope representing a sudden collapse of the second subset of voids followed by a region of positive slope representing linear displacement of the composite material in proportion to the force.

18. The article of claim 14, wherein:
the first and second layers extend parallel to a surface of the composite material, the first layer being closer to the surface, and
in response to an increasing unidirectional force being applied to the surface, the composite material is configured to deform according to a displacement-force profile that has a region of positive slope representing linear displacement of the composite material in proportion to the force followed by a region of near-zero slope representing a sudden collapse of the second subset of voids.

19. The article of claim 14, wherein:
the first and second layers extend orthogonal to a surface of the composite material, each of the first and second layers being adjacent to the surface, and
in response to an increasing unidirectional force being applied to the surface, the composite material is configured to deform according to a displacement-force profile that has first and second regions of changing positive slope representing a progressive collapse of different portions of the second subset of voids, each of the first and second regions of changing positive slope being bounded by regions of constant positive slope representing linear displacement of the composite material in proportion to the force.

20. A method, comprising:
forming a material including a set of voids; and
selectively delivering a substance to a first subset of voids distributed in a first section of the material such that (1) the first subset of voids is inhibited from collapsing relative to a second subset of voids distributed in a second section of the material and (2) the first and second sections having different properties.

21. The method of claim 20, wherein forming the material includes forming the material using at least one of: molding, polymerization, casting, or three-dimension printing.

22. The method of claim 20, wherein selectively delivering the substance to the first subset of voids includes delivering the substance to the first subset of voids via at least one of:
openings into the first subset of voids from an exterior of the material, or internal vasculature connected to the first subset of voids.
